(19) United States
(12) Patent Application Publication
(10) Pub. No.: US 2011/0256318 A1
(43) Pub. Date: Oct. 20, 2011

(54) PROCESS FOR PREPARING AND TREATING A SUBSTRATE

(76) Inventors: David F. Sechnick, Mentor, OH (US); Steven William Cox, Toronto (CA)

(21) Appl. No.: 12/760,875

(22) Filed: Apr. 15, 2010

(51) Int. Cl. B05D 3/12; B05D 3/10

(52) U.S. Cl. 427/327; 427/299

(57) ABSTRACT

Processes for preparing and treating a substrate are disclosed. A process includes: a) applying a cleaning solution comprising at least an organic acid to at least a portion of the substrate; (b) rinsing at least a portion of the cleaning solution with a first rinsing step; (c) applying a chemical cleaner composition onto a portion of the substrate subjected to step (b); (d) rinsing at least a portion of the substrate with the chemical cleaner composition of step (c) with a second rinsing step; and (e) depositing a pretreatment coating composition onto at least a portion of the substrate subjected to step (d). Additional steps include (f) rinsing at least a portion of the substrate with the pretreatment coating composition with a third rinsing step; and (g) depositing a protective coating composition onto the substrate subjected to step (f). Additional processes including similar steps in different arrangements are also disclosed.

### FIELD OF INVENTION

The present invention pertains to preparing and treating a substrate, such as a magnesium substrate.

### BACKGROUND OF THE INVENTION

Magnesium is a metal with many commercial uses. Magnesium can be cast by sand, die, permanent mold, and precision investment methods; extruded into numerous shapes; and rolled (or wrought) into sheet, plate, or strip metal. Most end uses of magnesium require some degree of protection against corrosion and, in end uses which require paint, paint adhesion. Accordingly, a coating which improves the corrosion resistance and paint adhesion of magnesium is often applied to the metal prior to the final paint or other decorative finish being applied. Such coatings are referred to as pretreatments. Prior to the deposition of a pretreatment, however, it is important to sufficiently prepare the magnesium surface. Otherwise, the poorly prepared areas will become sources for poor paint adhesion, and likely, corrosion. In many instances, it has been determined that poor paint adhesion can be attributed to a poorly prepared specimen, and not to the performance of the pretreatment itself.

There are numerous surface preparation methods and preparation baths which have been used to clean magnesium. In their article, “Magnesium Finishing: Chemical Treatment and Coating Practices”, Reese W. Murray and James E. Hillis disclose four general cleaning processes of magnesium: mechanical cleaning, solvent cleaning, alkaline cleaning, and acid pickling. This article states that these methods can be used singly or in combination. This article lists a variety of acid pickles used in scale removal of the magnesium surface, and states that the selected pickling agent depends on the manner in which magnesium is formed. Only chromic acid is listed as a pickling agent for all forms of magnesium, and an acetic nitrate combination is disclosed as useful on wrought magnesium to remove mill scale. Mill scale consists chiefly of magnesium oxide and its hydrates, finely divided magnesium metal, and a carbon or carbonized oily lubricant. Mill scale is picked up by the rolled articles of magnesium during working and appears as scattered specks or imperfections in the rolled articles.

U.S. Pat. No. 6,126,997 discloses a method for treating magnesium die castings by utilizing hydroxyl acetic acid.

### SUMMARY OF THE INVENTION

In certain aspects, the present invention relates to a process for preparing and treating a substrate, for example, magnesium substrate. This process comprises: (a) applying a cleaning solution comprising at least one organic acid to at least a portion of the substrate; (b) performing a first rinsing step to at least a portion of the substrate cleaned with the cleaning solution of step (a); (c) applying a chemical cleaner composition onto a portion of the substrate rinsed with the first rinsing step of step (b); (d) performing a second rinsing step to at least a portion of the substrate cleaned with the chemical cleaner composition of step (c); and (e) depositing a pretreatment coating composition onto at least a portion of the substrate subjected to step (d). In certain embodiments, this process further comprises (f) performing a third rinsing step to at least a portion of the substrate with the pretreatment coating composition of step (e); and (g) depositing a protective coating composition onto the substrate subjected to step (f).

In other aspects, the present invention relates to a process for preparing and treating a substrate, for example, magnesium substrate. This process comprises: (a) performing a first rinsing step to at least a portion of the substrate; (b) applying a cleaning solution comprising at least an organic acid to at least a portion of the substrate rinsed with the first rinsing step (a); (c) performing a second rinsing step to at least a portion of the substrate cleaned in step (b); and (d) depositing a pretreatment coating composition onto at least a portion of the substrate rinsed with the second rinsing step (c). In certain embodiments, this process further comprises: (e) performing a third rinsing step to at least a portion of the substrate with the pretreatment coating composition; and (f) depositing a protective coating composition onto the substrate rinsed with the third rinsing step (e).

In still other aspects, the present invention relates to a process for preparing and treating a substrate, for example, a magnesium substrate. This process comprises: (a) applying a chemical cleaner composition onto at least a portion of the substrate; (b) performing a first rinsing step to at least a portion of the substrate cleaned with the chemical cleaner composition of step (a); (c) applying a cleaning solution comprising at least an organic acid excluding acetic acid onto a portion of the substrate subjected to step (b); (d) performing a second rinsing step to at least a portion of the substrate subjected to step (c); and (e) depositing a pretreatment coating composition onto at least a portion of the substrate subjected to step (d). In certain embodiments, this process further comprises (f) performing a third rinsing step to at least a portion of the substrate subjected to step (e); and (g) depositing a protective coating composition onto the substrate subjected to step (f).

### DETAILED DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

It should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

The terms “activation”, “activating” and “surface preparation” are used interchangeably and refer to a process of creating a substrate surface that reacts in a more kinetically, favorable way to subsequent chemical treatment steps.

The terms “treating” and “treatment” refer to any step in the process that alters the original substrate surface to improve corrosion resistance and paint adhesion.

The term “magnesium alloy” refers to any commercially available metallic alloy containing magnesium at a higher content compared to any other element in the metallic alloy.

The term “ambient temperature” means treatment solutions operated at room temperature.

The term “dwell time” means the amount of time the substrate contacts the rinse water and/or treatment solution.

The invention relates to several processes for preparing and treating a surface of a substrate for enhancing corrosion resistance and/or paint adhesion of the substrate surface. In some non-limiting embodiments, the substrate comprises magnesium or magnesium alloys. Magnesium alloys for which the process of the present invention may be suitable include AZ91D and AM60B. Magnesium alloy sheet, casting, or extrusion can be treated by the process or processes of the invention. Other metals and metal alloys suitable for treatment by the invention include steel and aluminum alloys. Even though substrates comprising these other metals and/or metal alloys may be suitable for treatment by the processes of the invention, the invention will be described with reference to a magnesium substrate.

In an embodiment of the present invention, a process for preparing and treating the surface of a substrate, for example, magnesium substrate includes activating and cleaning the surface prior to depositing a pretreatment and subsequent to further corrosion protection afforded by a paint film. In a specific non-limiting example, this process includes a first step of activating and cleaning the surface by exposing the magnesium substrate to a low temperature acidic solution. The acid-activated surface is then rinsed with a first rinsing step comprising at least a water rinsing solution, for example, city or tap water, to stop the activation step and to remove the activating chemicals. The rinsed surface is then exposed to a high alkaline solution to remove smut formed during the activation and cleaning step. The alkaline treated substrate surface is then rinsed again. In some embodiments, the substrate is subjected to at least two rinsing solutions; a first rinsing solution comprising water and a second rinsing solution comprising water, for example, city water or tap water, to remove the alkaline desmutting solution. The activated, cleaned and desmutted magnesium substrate surface is then pretreated with a pretreatment coating composition, e.g. a non-chromium-based composition, e.g. a zirconium-based composition, and a chromium-based chemical treatment solution, for enhancing corrosion resistance and paint adhesion. The substrate that has been pretreated with the pretreatment coating composition is then rinsed thoroughly with a third rinsing step which may comprise at least two rinsing solutions wherein a first rinsing solution comprises water, e.g. city or tap water, and a second rinsing solution comprises pure water, i.e. either deionized water or reverse osmosis water, in order to stop the deposition of the pretreatment coating composition on the substrate surface, to remove the un-reacted pretreatment salts from the surface, and to remove any residue of the chemicals used in the various steps of this process. The final step of this process includes painting the magnesium substrate.

A specific representation of the preceding process for preparing and treating a substrate according to a first embodiment of the present invention is as follows:

### Process A:

(a) Activation and cleaning—the magnesium substrate is contacted with an acidic solution, for example, citric acid.
(b) Water rinse.
(c) Desmutting and cleaning—the magnesium substrate is contacted with an alkaline solution.
(d) Two water rinses.
(e) Pretreatment—the activated and desmutted magnesium substrate is contacted with a non-chromium based, e.g. zirconium or chromium-based chemical treatment solution.
(f) Two water rinses; one including a pure water rinse.
(g) Protecting.

Another embodiment of process A may be as follows:
(a) Activating and cleaning—A cleaning solution comprising at least an organic acid is applied to the substrate, for example, citric acid.
(b) Rinsing—The substrate is rinsed with a first rinsing step comprising at least a water rinsing solution.
(c) Desmutting and cleaning—A chemical cleaner composition is applied to the substrate.
(d) Rinsing—The substrate is rinsed with a second rinsing step comprising at least two water rinsing solutions.
(e) Pretreating—A pretreatment coating composition is deposited onto the substrate.
(f) Rinsing—The substrate is rinsed with a third rinsing step comprising at least two water rinsing solutions wherein a first rinsing solution comprises water and a second rinsing solution comprises pure water.
(g) Protecting—Depositing a protective coating composition, such as an electrodeposition coating (electrocoat), onto the substrate.

In the above steps (a) through (g), the solutions and compositions may contact, be applied or deposited onto the substrate surface by any known coating technique including: spray; dip (immersion); flow coating; and roll coating.

Step (a) of process A includes applying a cleaning solution comprising at least an organic acid to the substrate to clean and activate the magnesium alloy surface. In so doing, an acid-activated magnesium substrate is formed whereby oxides and metal impurities are eliminated from the surface of the substrate. In certain non-limiting embodiments, the cleaning solution is an aqueous solution of an organic acid. Specific examples of suitable organic acids include, but are not limited to citric acid, acetic acid, lactic acid, maleic acid, malic acid, oxalic acid, succinic acid, sebacic acid, tartaric acid, and gluconic acid, among many others. In some non-limiting embodiments, the cleaning solution is an aqueous solution of a citric acid. A suitable citric acid-based activating solution is sold under the trademark CORROSOL® 32 by PPG Industries, Inc.

In certain embodiments of process A, the cleaning solution of step (a) is often conducted at ambient temperature. As stated hereinabove, “ambient temperature” means that the treatment solutions are conducted at room temperature. In some embodiments, the temperature of the cleaning solution may be between 60° F. (15.5° C.) and 100° F. (37.8° C.) such as between 70° F. (21.1° C.) and 90° F. (32.2° C.). Yet in other embodiments, the temperature may be between 75° F. (23.9° C.) and 85° F. (29.4° C.). In some embodiments, the pH of the cleaning solution may be between 0.5 and 4.0, such as between 1.0 and 3.0. In other embodiments, the pH of the cleaning solution may be between 1.5 and 2.0.

In certain embodiments, the total acidity of the cleaning solution of step (a) may often be in the range of 10 points and 30 points of total acidity, such as 15 points and 25 points. In some embodiments, the total acidity of the cleaning solution of step (a) may often be 20 points. Total acid points may be defined as the volume in milliliters of a standard concentration of sodium hydroxide solution needed to reach the phenolphthalein (titrating indicator) end point in an acid-base titration. Total acidity is the quantitative measure of concentration and can be related to the activity level of the acid in the process solution.

The temperature and pH ranges of the cleaning solution of step (a) of process A often may vary depending on the dwell time, which is the amount of time the cleaning solution of step (a) contacts the substrate.

In certain embodiments, the cleaning solution of step (a) of process A may comprise a surfactant. Surfactants are incorporated on occasion to affect better wetting and rinsing of the substrate being activated and/or cleaned. Any acid compatible surfactant may be suitable for this purpose. An example of a surfactant that may be used in the cleaning solution of step (a) is sold under the trademark Triton DF-16 by Dow Chemical Company.

As stated herein above, the cleaning solution of step (a) comprises at least an organic acid for activating and cleaning the surface of the substrate by removing organic and/or inorganic impurities. During step (a), smut is often formed on the magnesium alloy surface. The smut formed on the surfaces of the substrate often contains oxides, hydroxides and/or oxy-hydroxides, and inorganic impurities. Removal of these oxides, hydroxides and impurities is affected by step (c) which comprises applying a chemical cleaner composition to the substrate surface, more about which is discussed herein below.

The above steps (b), (d) and (f) involve rinsing the substrate. In certain embodiments, step (b) comprises performing a first rinsing step to a portion of the substrate. In certain non-limiting embodiments, this step (b) comprises rinsing the substrate at least once with a water rinsing solution. The water rinsing solution of step (b) is applied to at least a portion of the substrate containing the cleaning solution of step (a) in order to interrupt and/or lessen activation of the cleaning solution of step (a) on the substrate, thereby forming an adequately activated magnesium substrate.

In certain embodiments, step (d) comprises performing a second rinsing step to a portion of the substrate. In certain non-limiting embodiments, this step (d) comprises rinsing the substrate at least twice with two rinsing solutions, both rinsing solutions comprising water.

In certain embodiments, step (f) comprises performing a third rinsing step to a portion of the substrate. In certain non-limiting embodiments, this step (f) comprises rinsing the substrate at least twice with two rinsing solutions, one rinsing solution comprising water, for example, city or tap water, and the other rinsing solution comprising pure water, for example, deionized water or reverse osmosis water.

In certain embodiments, the rinsing solution of steps (b), (d) and (f) comprise water. This water may be obtained from conventional city water sources. In certain embodiments, the temperature of the water may be at ambient temperature. Ambient temperature shall mean treatment solutions operated at room temperature. In some cases, the temperature of the water may range between 60° F. (15.5° C.) and 100° F. (37.8° C.), such as 70° F. (21.1 C) and 90° F. (32.2° C.). In some cases, this temperature may range between 75° F. (23.9° C.) and 85° F. (29.4° C.).

In certain embodiments, the water of the rinsing solution of steps (b), (d) and (f) often has a maximum hardness of 150 ppm as dissolved magnesium and calcium ions. In certain embodiments, the water source may often have a maximum conductivity of 450 microsiemens. In certain embodiments, the pure water source of the rinsing solution of step (f) may have a maximum conductivity of 200 microsiemens. In certain embodiments, the pure water source of the rinsing solution of step (f) may often have a maximum conductivity of 50 microsiemens. In certain embodiments, the pure water source comprises high purity sources, such as fresh (or virgin) deionized water sources and/or fresh (or virgin) reverse osmosis water sources.

Step (c) of process A comprises applying a chemical cleaner composition onto a portion of the substrate subjected to step (b). This step (c) cleans the substrate to the extent that contamination is decreased and smut is removed from the substrate. In certain embodiments, the chemical cleaner composition of step (c) comprises an aqueous solution. In certain embodiments, the chemical cleaner composition of step (c) comprises a highly alkaline solution, a neutral solution, a solvent-based solution, and a solvent emulsion.

In certain embodiments, the chemical cleaner composition of step (c) comprises hydroxides, silicates, carbonates, gluconates, simple and complex phosphates, phosphonates, aliphatic and aromatic solvents, glycol ethers, organic surface active agents, emulsifiers, and mixtures thereof. Suitable examples of hydroxides include sodium hydroxide and potassium hydroxide. A suitable sodium hydroxide based de-smutting agent sold under the trademark CORROSOL® 52921 by PPG Industries, Inc. has been determined to be effective for this purpose of step (c). A suitable alkaline degreaser sold under the trademarks CHEMKLEEN™, MAGNUSPRAY®, GILLITE®, AND ULTRAX® by PPG Industries may be used as a chemical cleaner composition in step (c).

Suitable examples of silicates include sodium silicate or sodium metasilicate. Suitable examples of carbonates include sodium carbonate or sodium sesquicarbonate. Suitable examples of gluconates include sodium gluconate. Suitable examples of simple phosphates include trisodium phosphate and disodium phosphate. Suitable examples of complex phosphates include sodium tripolyphosphate and tetrapotassium pyrophosphate. Suitable examples of phosphonates include hydroxy-ethylidene diphosphonic acid. Suitable examples of aliphatic solvents include mineral spirits. Suitable examples of aromatic solvents include toluene and xylene. Suitable examples of glycol ethers include ethylene glycol monobutyl ether and propylene glycol diethyl ether. Suitable examples or organic surface active agents include alkyl aryl sulfonates, ethylene oxide/propylene oxide block polymers, linear alcohols, and alkyl phenol ethoxylates. Suitable examples of emulsifiers include phosphate esters.

In certain embodiments, the chemical composition of step (c) comprises an aqueous solution that is conducted at a temperature ranging from 130° F. (54.4° C.) to 150° F. (65.5° C.), such as 135° F. (57.2° C.) to 145° F. (62.8° C.), and in some embodiments at 140° F. (60° C.), although the temperature range may vary depending on the concentration of the aqueous solution of the chemical cleaner composition, the pH value of the chemical cleaner composition, and the dwell time of the chemical cleaner composition on the substrate. In certain embodiments, the pH of the chemical cleaner composition ranges from 7.0 to 14.00, such as 10.5 to 12.5, and in some embodiments from 11.0 to 12.0. In certain embodiments, the chemical cleaner composition of step (c) is in the range of 5 points to 50 points of free alkalinity, such as from 5 points to 15 points of free alkalinity, and in some embodiments, from 25 points to 40 points of free alkalinity. Free alkalinity points may be defined as the volume in milliliters of a standard concentration sulfuric acid or hydrochloric acid titration needed to reach the phenolphthalein (titrating indicator) end point in an acid-base titration. Free alkalinity is the quantitative measure of concentration, and can be related to the activity level of the alkali in the process solution.

In certain embodiments, the chemical cleaner composition of step (c) is in an aqueous solution form and may optionally contain one or more surfactants. Surfactants are often incorporated into aqueous solution in order to affect better wetting, cleaning and rinsing of the substrate being de-smutted. Any alkaline compatible surfactant may be suitable in the aqueous solution comprising the chemical cleaner composition of step (c). A wide variety of suitable surfactants are commercially available. In certain embodiments, the de-smutting baths of step (c) may optionally contain chelating or sequestering agents. Suitable examples of such agents include salts of gluconic acid, tartartic acid, citric acid, and certain phosphates and phosphonates. An addition of sodium gluconate to the de-smutting bath of step (c) is particularly effective as a sequestering agent. Chelating and sequestering agents are often incorporated into a de-smutting bath in order to complex certain metal ions. Complexing the metal ions in the de-smutting bath often enables a more effective use of the de-smutting solution.

The above steps (a) through (d), in general, effectively remove all impurities from the surface or surfaces of the substrate and activate the surface or surfaces of the substrate in preparation for a subsequent treatment of step (e).

Step (e) of process A comprises depositing a pretreatment coating composition onto at least a portion of the substrate subjected to step (d). In some embodiments, this pretreatment coating composition comprises non-chromium based, chromium based and zinc phosphate based conversion coating compositions. In certain embodiments, this pretreatment coating composition is an aqueous solution which improves the paint adhesion and/or corrosion resistance of a metal surface, for example, magnesium or magnesium alloy substrate.

In certain non-limiting embodiments, this pretreatment coating composition of step (e) comprises a zirconium-based agent. In some embodiments, this zirconium-based agent is an aqueous solution of zirconium ions. The source of zirconium ions is typically from zirconium carbonate, zirconium nitrate, hexafluorozirconic acid, and mixtures thereof. Often, this source of zirconium ions is from hexafluorozirconic acid. A zirconium based pretreatment agent sold under the trademark XBOND® or ZIRCOBOND® by PPG Industries has been determined to be effective for step (e).

In some embodiments, the pretreatment coating composition of step (e) comprises a chromate-based agent. In some embodiments, the chromate-based agent is an aqueous solution. A suitable chromate based pretreatment agent sold under the trademark ZETACHROME™ 400 by PPG Industries has been determined to be effective for step (e).

In some embodiments, step (e) is conducted at ambient temperature. Ambient temperature shall mean treatment solutions operated at room temperature, such as between 55° F. (12.8° C.) and 110° F. (43.3° C.). In some embodiments, the pH of the pretreatment coating composition of step (e) is at a pH ranging from 1.5 to 5.0, such as 2.0 to 3.0, and in some embodiments at a pH of 2.5.

After the pretreatment of step (e), as stated herein above, according to step (f) the portion of the substrate subjected to step (e) is then subjected to a third rinsing step. In certain non-limiting embodiments, this third rising step comprises rinsing the substrate at least twice with two different rinsing solutions, a first rinsing solution comprising water and a second rinsing solution comprising pure water. In some embodiments, the first rinsing solution comprising water may have the same characteristics as the water for the rinsing solution of steps (b) and (d). In some embodiments, the pure water has a temperature ranging between 55° F. (12.8° C.) and 130° F. (54.4° C.). In some embodiments, after step (f), the substrate is often dried, for example, by an oven and then a decorative and protective coating is applied to the dried substrate in accordance with step (g).

Step (g) of the process for preparing and treating a substrate of process A comprises depositing a protective coating composition onto at least a portion of the substrate subjected to step (f). In certain non-limiting embodiments, the protective coating composition may include a decorative paint, such as powder paint and liquid paint, and in some embodiments, an electrodeposited paint coating. In some embodiments, step (g) comprises painting the substrate surface or surfaces with a cationic epoxy electrocoat. A suitable cationic epoxy electrocoat is commercially available under the trademark POWERCRON® 590-534 sold by PPG Industries. In some embodiments, the film thickness of the protective coating composition on the surface of the substrate ranges between 0.6 mils (15 μm) and 1.3 mils (33 μm).

A further process for treating a substrate of the present invention involves Process B. This process B has also been found to be effective in activating the surface of a substrate, for example, a metal substrate, such as magnesium and magnesium alloys prior to the pretreatment step comprising contacting the substrate with a zirconium-based solution or a chromate-based solution.

### Process B:

(a) Hot water rinse
(b) Activation and cleaning—the magnesium substrate is contacted with an acidic solution, for example, citric acid.
(c) Two water rinses—one hot water rinse and one pure water rinse.
(d) Pretreatment—the activated and de-smutted magnesium substrate is contacted with a non-chromium or chromium-based chemical treatment solution.
(e) Two water rinses—one water rinse and one pure water rinse.
(f) Protecting.

Another embodiment of process B is as follows:
(a) Rinsing—The substrate is rinsed with a first rinsing step comprising a first rinsing solution comprising hot water.
(b) Activating and cleaning—A cleaning solution comprising at least an organic acid is applied to the substrate.
(c) Rinsing—The substrate is rinsed with a second rinsing step comprising at least two rinsing solutions wherein a first rinsing solution comprises hot water and a second rinsing solution comprises pure water.
(d) Pretreatment—A pretreatment coating composition is deposited onto the substrate.
(e) Rinsing—The substrate is rinsed with a third rinsing step comprising at least two rinsing solutions wherein a first rinsing solution comprises water and a second rinsing solution comprises pure water.
(f) Protecting—Depositing a protective coating composition, such as electrodeposition coating (electrocoat), onto the substrate.

In effect, process B eliminates step (d) of process A and comprises performing a series of rinsing steps (a), (c) and (e). In some embodiments, the first rinsing step (a) comprises a first rinsing solution comprising hot water. In some embodiments, the second rinsing step (c) comprises at least two rinsing solutions, a first rinsing solution comprising hot water, for example city or tap water, and a second rinsing solution comprising pure water, such as deionized water and reverse osmosis water. In some embodiments, the third rinsing step (e) comprises at least two rinsing solutions, a first rinsing solution comprising water and a second rinsing solution comprising pure water, such as deionized water and reverse osmosis water.

In certain embodiments of process B, the temperature of the hot water of steps (a) and (c) may range between 212° F. (100° C.) and 180° F. (82.2° C.), such as between 130° F. (54.4° C.) and 150° F. (65.5° C.); in some cases, such as between 135° F. (57.2° C.) and 145° F. (62.8° C.); and in some cases, 140° F. (60° C.). In contrast, in certain embodiments of process B, the temperature of the water of step (e), which may be clean city water, may range between 60° F. (15.5° C.) and 100° F. (37.8° C.), such as 70° F. (21.1 C) and 90° F. (32.2° C.). In some cases, this temperature may range between 75° F. (23.9° C.) and 85° F. (29.4° C.).

The parameters and further particulars of steps (a) through (g) of process B are similar to those discussed herein above for steps (a) through (g) of process A, except as noted herein above.

A further process of the present invention includes process C. Specific steps of process C include the following:

### Process C:

(a) De-smutting and cleaning—the magnesium substrate is contacted with an alkaline solution, for example, an alkaline degreaser.
(b) Water rinse—one water rinse.
(c) Activation and cleaning—the magnesium substrate is contacted with an acidic solution, for example, citric acid.
(d) Two water rinses—one water rinse and one pure water rinse.
(e) Pretreatment—the activated magnesium substrate is contacted with non-chromium or chromium-based chemical treatment solution.
(f) Two water rinses—one water rinse and one pure water rinse.
(g) Protecting.

Another embodiment of process C is as follows:
(a) De-smutting and cleaning—A chemical cleaner composition is applied to the substrate.
(b) Rinsing—The substrate is rinsed with a first rinsing step comprising at least one rinsing solution comprising water.
(c) Activating and cleaning—A cleaning solution comprising at least an organic acid is applied to the substrate.
(d) Rinsing—The substrate is rinsed with a second rinsing step comprising at least two rinsing solutions wherein a first rinsing solution comprises water and a second rinsing solution comprises pure water.
(e) Pretreatment—A pretreatment coating composition is deposited onto the substrate.
(f) Rinsing—The substrate is rinsed with a third rinsing step comprising at least two rinsing solutions wherein a first rinsing solution comprises water and a second rinsing solution comprises pure water.
(g) Protecting—Depositing a protective coating composition, such as an electrodeposition coating (electrocoat), onto the substrate.

In effect, process C begins with de-smutting and cleaning step (a) and includes performing a series of rinsing steps (b), (d) and (f), an activating and cleaning step (c), a pretreatment step (e) and a protecting step (g). In some embodiments, performing the first rinsing step (b) comprises a rinsing solution comprising water. In some embodiments, performing the second rinsing step (d) comprises at least two rinsing solutions; a first rinsing solution comprising water, for example, city or tap water, and a second rinsing solution comprising pure water, such as deionized water and reverse osmosis water. In some embodiments, performing the third rinsing step (f) comprises at least two rinsing solutions, a first rinsing solution comprising water, for example, city or tap water, and a second rinsing solution comprising pure water, such as deionized water and reverse osmosis water.

In certain embodiments of process C, the water of steps (b), (d) and (f) may be clean water and in some instances, clean city water. The temperature of the water and the pure water of steps (b), (d) and (f) may range between 60° F. (15.5° C.) and 100° F. (37.8° C.), such as 70° F. (21.1 C) and 90° F. (32.2° C.). In some cases, this temperature may range between 75° F. (23.9° C.) and 85° F. (29.4° C.).

In certain embodiments of process C, the de-smutting and cleaning step (a) may comprise a chemical cleaner composition comprising an alkaline degreaser. In certain embodiments, the activating and cleaning step (a) comprises a cleaning solution comprising at least an organic acid. In certain non-limiting embodiments, the cleaning solution is an aqueous solution of an organic acid. Specific examples of suitable organic acids include, but are not limited to citric acid, acetic acid, lactic acid, maleic acid, malic acid, oxalic acid, succinic acid, sebacic acid, tartaric acid, and gluconic acid among many others. In some non-limiting embodiments, the cleaning solution is an aqueous solution of a citric acid. A suitable citric acid-based activating solution is sold under the trademark CORROSOL® 32 by PPG Industries, Inc. In certain non-limiting embodiments, the cleaning solution is an aqueous solution of an organic acid excluding acetic acid.

The parameters and particulars of steps (a) through (g) of process C are similar to those disclosed above for steps (a) through (g) of process A, except as noted above.

The following examples are presented to demonstrate the general principles of the invention. However, the invention should not be considered as limited to the specific examples presented. It is to be noted that Example 1 is representative of process A; Example 2 is representative of process B; and Example 3 is representative of process C of the present invention.

### EXAMPLES

### Example 1

### Process A of the Present Invention

In Example 1, several AM60B magnesium panels were treated in preparation for painting. The several treatment schemes are outlined in Table 1. The magnesium test specimens were treated using a dip application method. Experiment Nos. 1, 2 and 3 were treated according to prior art processes. Experiment No. 4 is a control experiment. Experiment Nos. 5 and 6 were treated according to steps (a) through (f) of process A of the present invention.

TABLE 1
Treatment Schemes

| Experiment | | | | | | | | |
|---|---|---|---|---|---|---|---|---|
| Nos. | Step 1 | Step 2 | Step 3 | Step 4 | Step 5 | Step 6 | Step 7 | Step 8 |
| 1 | Alkaline | City | Phosphoric | City | Deionized | na | na | na |
| | degrease | water | Acid | water | water | | | |
| | | rinse | Deoxidize | rinse | rinse | | | |
| 2 | Alkaline | City | Phosphoric | City | Chromate | City | Deionized | na |
| | degrease | water | Acid | water | treatment | water | water | |
| | | rinse | Deoxidize | rinse | | rinse | rinse | |
| 3 | Alkaline | City | Phosphoric | City | Zirconium | City | Deionized | na |
| | degrease | water | Acid | water | treatment | water | water | |
| | | rinse | Deoxidize | rinse | | rinse | rinse | |
| 4 | Citric acid | City | Alkaline de- | City | City | Deionized | na | na |
| | | water | smut | water | water | water | | |
| | | rinse | | rinse | rinse | rinse | | |
| 5 | Citric acid | City | Alkaline de- | City | City | Chromate | City | Deionized |
| | | water | smut | water | water | treatment | water | water |
| | | rinse | | rinse | rinse | | rinse | rinse |
| 6 | Citric acid | City | Alkaline de- | City | City | Zirconium | City | Deionized |
| | | water | smut | water | water | treatment | water | water |
| | | rinse | | rinse | rinse | | rinse | rinse |

*na - means non-applicable

The treatment type, corresponding commercial products, and application parameters used in Example 1 are summarized in Table 2.

All test specimens were treated according to the schemes outlined in Table 1 and then subsequently painted with POWERCRON® 590-534, which is a cationic epoxy electrocoat sold by PPG Industries, under the following conditions: (1) bath temperature—90° F. (32° C.); (2) DC voltage—230 volts; (3) dwell time—90 seconds; and (4) paint cure—20 minutes at 375° F. (190° C.) peak metal temperature. The targeted final electrocoated film thickness was 0.8-1.0 mils (20-25 μm).

TABLE 2
Treatment Descriptions and Parameters
for Dip Processing of Magnesium Alloys

| | PPG | | | | Dwell |
|---|---|---|---|---|---|
| Treatment | Product | Concentration | | Temperature | Time |
| Alkaline | Chemkleen | 2 | v/o % | 140° F. (60° C.) | 60 sec |
| Degreaser | 611L | | | | |
| Rinse | City water | Na | | 70° F. (21° C.) | 30 sec |
| Rinse | Deionized | Na | | 70° F. (21° C.) | 30 sec |
| | water | | | | |
| Chromate | Zetachrome | 4.4 | v/o % | 110° F. (43° C.) | 60 sec |
| treatment | 400 | | | | |
| Zirconium | XBond 4000 | 6.0 | v/o % | 85° F. (29° C.) | 60 sec |
| treatment | | | | | |
| Citric Acid | Corrosol 32 | 10.0 | v/o % | 70° F. (21° C.) | 60 sec |
| treatment | | | | | |
| Alkaline | Corrosol | 10.0 | v/o % | 140° F. (60° C.) | 60 sec |
| Desmutter | 52921 | | | | |
| Acidic | DX533 | 10.0 | v/o % | 70° F. (21° C.) | 60 sec |
| Deoxidizer | | | | | |

Five (5) test specimens, each having a dimension of approximately 4 in×6 in (10.2 cm×15.2 cm) were used per test variable. Treated and painted specimens were performance tested as outlined in Table 3. Treated and painted specimens designated for neutral salt-spray, cyclic corrosion, and hot salt-water soak were pre-scribed prior to testing. Two intersecting diagonal scribes were introduced into the paint specimen using an E-5, C6 scribing tool. At the conclusion of the performance test, specimens were removed from the test chamber, rinsed with city water, dried with a clean white disposable paper towel, and adhesion tested within ten (10) minutes after removal from the test chamber. Paint loss was determined using a tape pulled method according to ASTM D1654. The tape used was Scotch brand number 8981. Paint adhesion loss was measured from the center of the scribe line to the point where paint remained adhered to the surface of the substrate. Passing results are also listed in Table 3 for the various performance tests.

TABLE 3
Performance Tests

| Test | Specification | Test Duration | Passing ⁽²⁾ |
|---|---|---|---|
| Neutral Salt | ASTM B117 | 744 hours | 3.0 mm or less |
| Spray | | | |
| Boiling Water | | 20 minutes | 4B or greater ⁽³⁾ |
| Wet Adhesion ⁽¹⁾ | | | |
| 5% Hot Salt | Honda | 96 hours | 3.0 mm or less |
| Water Soak | | | |

⁽¹⁾ Painted test specimens were cross-hatch scribed prior to exposure to the boiling water.
⁽²⁾ Paint adhesion loss along scribe lines as determined by a tape pull test.
⁽³⁾ Panels were rated according to ASTM D3359.

The performance test data are summarized in Table 4. The experiments highlighted in gray passed all performance tests. These experiments are experiment Nos. 5 and 6, which represent the steps of process A of the present invention. These experiment Nos. 5 and 6 gave identical performance test results. Both experiment Nos. 5 and 6 involved a surface activation treatment using citric acid for Step 1 and an alkaline de-smutting step for Step 3, followed by either a chromium-based treatment (Experiment No. 5) or a zirconium-based treatment (Experiment No. 6). All other experiment Nos. 1 through 4 exhibited a failure in one or more of the performance tests.

This Example 1 demonstrates improved performance testing for a AM60B magnesium alloy treated by the steps of process A (Experiment Nos. 5 and 6), which process involves the use of citric acid in Step 1 compared to a AM60B magnesium alloy treated by the steps of the prior art industrial processes (Experiment Nos. 1, 2, and 3) which involve an alkaline degreaser step for Step 1 and a mineral acid deoxidizer for Step 3. Experiment No. 4 is a control.

TABLE 4
Performance Test Data

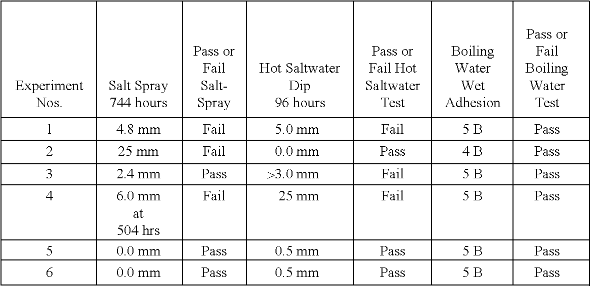

### Example 2

### Process B of the Present Invention

In Example 2, several AZ91D magnesium panels were treated in preparation for painting. The several treatment schemes employed in this experiment are outlined in Table 5. The magnesium test specimens were pretreated using a dip application method.

TABLE 5
Treatment Schemes

| Experiment | | | | | | | |
|---|---|---|---|---|---|---|---|
| Nos. | Step 1 | Step 2 | Step 3 | Step 4 | Step 5 | Step 6 | Step 7 |
| 1 | Alkaline | City | Phosphoric | City | Deionized | na | na |
| | degrease | water | Acid | water | water | | |
| | | rinse | Deoxidize | rinse | rinse | | |
| 2 | Alkaline | City | Phosphoric | City | Chromate | City | Deionized |
| | degrease | water | Acid | water | treatment | water | water |
| | | rinse | Deoxidize | rinse | | rinse | rinse |
| 3 | Alkaline | City | Phosphoric | City | Zirconium | City | Deionized |
| | degrease | water | Acid | water | treatment | water | water |
| | | rinse | Deoxidize | rinse | | rinse | rinse |
| 4 | Hot City | Citric | Hot City | Deionized | Chromate | City | Deionized |
| | Water | Acid | Water | water | treatment | Water | water |
| | Rinse | | Rinse | rinse | | Rinse | rinse |
| 5 | Hot City | Citric | Hot City | Deionized | Zirconium | City | Deionized |
| | Water | Acid | Water | water | treatment | water | water |
| | Rinse | | Rinse | rinse | | rinse | rinse |

Experiment No. 1 is a control. Experiment Nos. 2 and 3 were treated according to the processes of the prior art. Experiment Nos. 4 and 5 were treated according to the steps of process B of the present invention.

The treatment type, corresponding commercial products, and application parameters used for Example 2 are summarized in Table 6.

TABLE 6
Treatment Descriptions and Parameters
for Dip Processing of Magnesium Alloys

| | PPG | | | Dwell |
|---|---|---|---|---|
| Treatment | Product | Concentration | Temperature | Time |
| Alkaline | Chemkleen | 2 v/o % | 140° F. (60° C.) | 60 sec |
| Degreaser | 611L | | | |
| Rinse | City water | na | 70° F. (21° C.) | 30 sec |
| Rinse | Deionized | na | 70° F. (21° C.) | 30 sec |
| | water | | | |
| Hot rinse | City water | na | 140° F. (60° C.) | 30 sec |
| Chromate | Zetachrome | 4.4 v/o % | 110° F. (43° C.) | 60 sec |
| treatment | 400 | | | |
| Zirconium | XBond 4000 | 6.0 v/o % | 85° F. (29° C.) | 60 sec |
| treatment | | | | |
| Citric Acid | Corrosol | 10.0 v/o % | 70° F. (21° C.) | 60 sec |
| treatment | 32 | | | |
| Acidic | DX533 | 10.0 v/o % | 70° F. (21° C.) | 60 sec |
| Deoxidizer | | | | |

All test specimens were treated according to the schemes outlined in Table 5 and then subsequently painted with POWERCRON® 590-534, which is a cationic epoxy electrocoat, provided by PPG Industries, under the following conditions: (1) bath temperature—90° F. (32° C.); (2) DC voltage—230 volts; (3) dwell time—90 seconds; and (4) paint cure—20 minutes at 375° F. (190° C.) peak metal temperature. The targeted final electrocoated film thickness was 0.8-1.0 mils (20-25 μm).

Five (5) test specimens, each having a dimension of approximately 4 in×6 in (10.2 cm×15.2 cm), were used per test variable. Treated and painted specimens were performance tested as outlined in Table 7. Treated and painted specimens designated for neutral salt-spray, cyclic corrosion and hot salt-water soak were pre-scribed prior to testing. Two intersecting diagonal scribes were introduced into the paint specimen using an E-5, C6 scribing tool. At the conclusion of the performance test, the specimens were removed from the test chamber, rinsed with city water, dried with a clean white disposable paper towel, and adhesion tested within ten (10) minutes after removal from the test chamber. Paint loss was determined using a tape pulled method according to ASTM D1654. The tape used was Scotch brand number 8981. Paint adhesion loss is measured from the center of the scribe line to the point where paint remains adhered to the substrate surface. Passing results are also listed in Table 7 for the various performance tests.

TABLE 7
Performance Tests

| Test | Specification | Test Duration | Passing ⁽²⁾ |
|---|---|---|---|
| Neutral Salt | ASTM B117 | 744 hours | 3.0 mm or less |
| Spray | | | |
| Boiling Water | | 20 minutes | 4B or greater ⁽³⁾ |
| Wet Adhesion ⁽¹⁾ | | | |
| 5% Hot Salt | Honda | 120 hours | 3.0 mm or less |
| Water Soak | | | |

⁽¹⁾ Painted test specimens were cross-hatch scribed prior to exposure to the boiling water.
⁽²⁾ Paint adhesion loss along scribe lines as determined by a tape pull test.
⁽³⁾ Panels were rated according to ASTM D3359.

The performance test data are summarized in Table 8. Only tests highlighted in light gray passed all performance tests. Only Experiment No. 5, treated according to the steps of process B of the present invention, gave a passing result in all performance tests. Experiment No. 5 involved using a citric acid cleaning and surface activation step in Step 2, followed by several rinsing steps and a subsequent zirconium treatment step (Step 5). No other Experiment Nos. 1 through 4 gave passing results for the performance tests. The effectiveness of the citric acid cleaning and activation step of Step 2 may be attributed to rinsing the AZ91D magnesium alloy with hot city water (Steps 1 and 3) having a temperature of 140° F. (60° C.). Even a chromate treatment step (Step 5) of Experiment No. 4 was ineffective when using the hot city water rinsing steps of Steps 1 and 3 having a temperature of 140° F. (60° C.).

TABLE 8
Performance Test Data

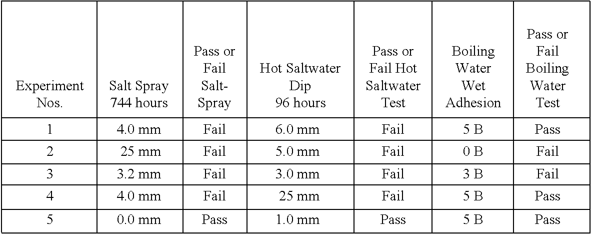

### Example 3

### Process C of the Present Invention

In Example 3, several AM60B magnesium panels were prepared for painting. The several treatment schemes are outlined in Table 9. The magnesium test specimens were treated using a dip application method.

TABLE 9
Treatment Schemes

| Experiment | | | | | | | |
|---|---|---|---|---|---|---|---|
| Nos. | Step 1 | Step 2 | Step 3 | Step 4 | Step 5 | Step 6 | Step 7 |
| 1 | Alkaline | City | Phosphoric | City | Deionized | na | na |
| | degrease | water | Acid | water | water | | |
| | | rinse | Deoxidize | rinse | rinse | | |
| 2 | Alkaline | City | Phosphoric | City | Chromate | City | Deionized |
| | degrease | water | Acid | water | treatment | water | water |
| | | rinse | Deoxidize | rinse | | rinse | rinse |
| 3 | Alkaline | City | Phosphoric | City | Zirconium | City | Deionized |
| | degrease | water | Acid | water | treatment | water | water |
| | | rinse | Deoxidize | rinse | | rinse | rinse |
| 4 | Alkaline | City | Citric | Deionized | Chromate | City | Deionized |
| | degrease | water | Acid | water | treatment | Water | water |
| | | rinse | | rinse | | Rinse | rinse |
| 5 | Alkaline | City | Citric | Deionized | Zirconium | City | Deionized |
| | degrease | water | Acid | water | treatment | water | water |
| | | rinse | | rinse | | rinse | rinse |

Experiment No. 1 is a control. Experiment Nos. 2 and 3 were treated according to the processes of the prior art. Experiment Nos. 4 and 5 were treated according to the steps of process C of the present invention.

The treatment type, corresponding commercial products, and application parameters used for Example 3 are summarized in Table 10.

TABLE 10
Treatment Descriptions and Parameters
for Dip Processing of Magnesium Alloys

| | PPG | | | Dwell |
|---|---|---|---|---|
| Treatment | Product | Concentration | Temperature | Time |
| Alkaline | Chemkleen | 2 v/o % | 140° F. (60° C.) | 60 sec |
| Degreaser | 611L | | | |
| Rinse | City water | na | 70° F. (21° C.) | 30 sec |
| Rinse | Deionized | na | 70° F. (21° C.) | 30 sec |
| | water | | | |
| Chromate | Zetachrome | 4.4 v/o % | 110° F. (43° C.) | 60 sec |
| treatment | 400 | | | |
| Zirconium | XBond 4000 | 6.0 v/o % | 85° F. (29° C.) | 60 sec |
| treatment | | | | |
| Citric Acid | Corrosol | 10.0 v/o % | 70° F. (21° C.) | 60 sec |
| treatment | 32 | | | |
| Acidic | DX533 | 10.0 v/o % | 70° F. (21° C.) | 60 sec |
| Deoxidizer | | | | |

All test specimens were treated according to the schemes outlined in Table 9 and then subsequently painted with POWERCRON® 590-534, which is a cationic epoxy electrocoat, provided by PPG Industries, under the following conditions: (1) bath temperature—90° F. (32° C.); (2) DC voltage—230 volts; (3) dwell time—90 seconds; and (4) paint cure—20 minutes at 375° F. (190° C.) peak metal temperature. The targeted final electrocoated film thickness was 0.8-1.0 mils (20-25 μm).

Five (5) test specimens, each having a dimension of approximately 4 in×6 in (10.2 cm×15.2 cm), were used per test variable. Treated and painted specimens were performance tested as outlined in Table 11. Treated and painted specimens designated for neutral salt-spray, cyclic corrosion, and hot salt-water soak were pre-scribed prior to testing. Two intersecting diagonal scribes were introduced into the paint specimen using an E-5, C6 scribing tool. At the conclusion of the performance test, specimens were removed from the test chamber, rinsed with city water, dried with a clean white disposable paper towel, and adhesion tested within ten (10) minutes after being dried. Paint loss was determined using a tape pulled method according to ASTM D1654. The tape used was Scotch brand number 8981. Paint adhesion loss is measured from the center of the scribe line to the point where paint remains adhered to the substrate surface. Passing results are also listed in Table 7 for the various performance tests.

TABLE 11
Performance Tests

| Test | Specification | Test Duration | Passing ⁽²⁾ |
|---|---|---|---|
| Neutral Salt | ASTM B117 | 744 hours | 3.0 minor less |
| Spray | | | |
| Boiling Water | | 20 minutes | 4B or greater ⁽³⁾ |
| Wet Adhesion ⁽¹⁾ | | | |
| 5% Hot Salt | Honda | 120 hours | 3.0 mm or less |
| Water Soak | | | |

⁽¹⁾ Painted test specimens were cross-hatch scribed prior to exposure to the boiling water.
⁽²⁾ Paint adhesion loss along scribe lines as determined by a tape pull test.
⁽³⁾ Panels were rated according to ASTM D3359.

The performance test data are summarized in Table 12. Only tests highlighted in light gray passed all performance tests. Experiment Nos. 3, 4 and 5 gave passing results in all performance tests. This experiment used a traditional alkaline cleaning step (Step 1) followed by a deoxidizing step in Step 3 using a mineral acid (Experiment Nos. 1, 2 and 3 of the prior art) or followed by a citric acid step in Step 3 (Experiment Nos. 4 and 5 of the present invention). Although passing results were obtained for Experiment No. 3 which was not treated according to the process of the present invention, Experiment Nos. 4 and 5 (the invention) using a traditional process of an alkaline cleaning step (Step 1) followed by a deoxidizing step using a citric acid (Step 3) produced better results compared to Experiment No. 3. That is, the results of Experiment No. 3 are only marginal compared to those for Experiment Nos. 4 and 5 processed according to process C of the present invention. The data show that the invention provides a more robust process. That is, it provides for a larger window of process parameters to achieve a quality result.

TABLE 12
Performance Test Data

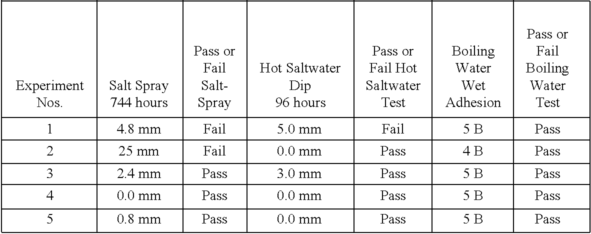

Even though embodiments herein have been exemplified using magnesium or magnesium alloys substrates, it is to be appreciated that other metals and non-metals may be effectively treated according to the processes of the present invention.

Whereas particular embodiments of the invention have been described herein above for purposes of illustration, it will be evident to those skilled in the art that numerous variations of the details of the present invention may be made without departing from the invention as defined in the appended claims.

1. A process for preparing and treating a substrate comprising:
(a) applying a cleaning solution comprising at least an organic acid to at least a portion of the substrate;
(b) performing a first rinsing step to at least a portion of the substrate cleaned with the cleaning solution of step (a);
(c) applying a chemical cleaner composition onto a portion of the substrate rinsed with the first rinsing step (b);
(d) performing a second rinsing step to at least a portion of the substrate cleaned with the chemical cleaner composition of step (c); and
(e) depositing a pretreatment coating composition onto at least a portion of the substrate subjected to step (d).

2. The process of claim 1 further comprising:
(f) performing a third rinsing step to at least a portion of the substrate with the pretreatment coating composition of step (e); and
(g) depositing a protective coating composition onto the substrate subjected to step (f).

3. The process of claim 2 wherein the first rinsing step (b) comprises at least a first rinsing solution comprising water; wherein the second rinsing step (d) comprises at least a first rinsing solution comprising water and a second rinsing solution comprising water; and wherein the third rinsing step (f) comprises at least a first rinsing solution comprising water and a second rinsing solution comprising pure water.

4. The process of claim 1 wherein step (a) is conducted at a temperature ranging between 60° F. (15.5° C.) and 100° F. (37.8° C.).

5. The process of claim 1 wherein the cleaning solution of step (a) has a pH ranging from 0.5 to 5.0; and wherein the chemical cleaner composition of step (c) has a pH ranging from 7.4 to 14.0.

6. The process of claim 1 wherein the organic acid of the cleaning solution of step (a) comprises citric acid, acetic acid, lactic acid, maleic acid, malic acid, oxalic acid, succinic acid, sebacic acid, tartaric acid, gluconic acid, and mixtures thereof.

7. The process of claim 1 wherein the chemical cleaner composition of step (c) comprises an alkaline cleaning solution, a neutral cleaning solution, a solvent-based cleaning solution, a solvent emulsion cleaning solution, and mixtures thereof.

8. The process of claim 1 wherein the pretreatment coating composition of step (e) comprises non-chromium-based coating compositions and chromium-based coating compositions.

9. A process for preparing and treating a substrate, comprising:
(a) performing a first rinsing step to at least a portion of the substrate;
(b) applying a cleaning solution comprising at least an organic acid to at least a portion of the substrate;
(c) performing a second rinsing step to at least a portion of the substrate cleaned with the cleaning solution of step (b); and
(d) depositing a pretreatment coating composition onto at least a portion of the substrate subjected to step (c).

10. The process of claim 9, further comprising:
(e) performing a third rinsing step to at least a portion of the substrate with the pretreatment coating composition of step (d); and
(f) depositing a protective coating composition onto the substrate rinsed with the third rinsing step of step (e).

11. The process of claim 10, wherein the first rinsing step (a) comprises a rinsing solution comprising hot water; wherein the second rinsing step (c) comprises at least two rinsing solutions wherein a first rinsing solution comprises hot water and a second rinsing solution comprises pure water; and wherein the third rinsing step (e) comprises at least two rinsing solutions wherein a first rinsing solution comprises water and a second rinsing solution comprises pure water.

12. The process of claim 11 wherein the temperature of the hot water of the rinsing solution of step (a) and the temperature of the hot water of the first rinsing solution of the second rinsing step (c) ranges from 130° F. (54.4° C.) to 150° F. (65.5° C.).

13. The process of claim 9 wherein the organic acid of step (b) is selected from citric acid, acetic acid, lactic acid, maleic acid, malic acid, oxalic acid, succinic acid, sebacic acid, tartaric acid, gluconic acid, and mixtures thereof.

14. The process of claim 9, wherein the pretreatment coating composition of step (d) comprises non-chromium-based coating compositions and chromium-based coating compositions.

15. A process for preparing and treating a substrate; comprising:
(a) applying a chemical cleaner composition onto at least a portion of the substrate;
(b) performing a first rinsing step to at least a portion of the substrate cleaned with the chemical cleaner composition of step (a);
(c) applying a cleaning solution comprising at least an organic acid excluding acetic acid onto a portion of the substrate subjected to step (b);
(d) performing a second rinsing step to at least a portion of the substrate subjected to step (c); and
(e) depositing a pretreatment coating composition onto at least a portion of the substrate subjected to step (d).

16. The process of claim 15 wherein the first rinsing step (b) comprises a rinsing solution comprising water; and wherein the second rinsing step (d) comprises at least two rinsing solutions wherein a first rinsing solution comprises water and a second rinsing solution comprises pure water.

17. The process of claim 15 further comprising:
(f) performing a third rinsing step to at least a portion of the substrate subjected to step (e); and
(g) depositing a protective coating composition onto at least a portion of the substrate subjected to step (f).

18. The process of claim 17 wherein the third rinsing step (f) comprises at least a first rinsing solution comprising water and a second rinsing solution comprising pure water.

19. The process of claim 15 wherein the organic acid of step (c) is selected from citric acid, lactic acid, maleic acid, malic acid, oxalic acid, succinic acid, sebacic acid, tartaric acid, gluconic acid and mixtures thereof.

20. The process of claim 15 wherein the chemical cleaner composition of step (a) comprises an alkaline cleaning solution, a neutral cleaning solution, a solvent cleaning solution; a solvent-based emulsion; and mixtures thereof.

21. The process of claim 15 wherein the pretreatment coating composition of step (e) comprises non-chromium based compositions and chromium-based compositions.

22. The process of claim 1, wherein the substrate comprises a magnesium substrate or a magnesium alloy substrate.

23. The process of claim 1, where the pretreatment coating composition comprises a zirconium-based agent.

24. The process of claim 9, wherein the substrate comprises a magnesium substrate or a magnesium alloy substrate.

25. The process of claim 9, where the pretreatment coating composition comprises a zirconium-based agent.

26. The process of claim 15, wherein the substrate comprises a magnesium substrate or a magnesium alloy substrate.

27. The process of claim 15, where the pretreatment coating composition comprises a zirconium-based agent.
